(19) United States
(12) Patent Application Publication
(10) Pub. No.: US 2005/0046374 A1
(43) Pub. Date: Mar. 3, 2005

(54) Information processor and rotation control device therefor

(75) Inventors: Tetsuo Ogawa, Sagamihara-shi (JP); Michio Suzuki, Yokohama-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/777,396

(22) Filed: Feb. 12, 2004

(30) Foreign Application Priority Data
Feb. 12, 2003 (JP) 2003-034177

(51) Int. Cl. G05B 5/01

(52) U.S. Cl. 318/614

(57) ABSTRACT

An information processor having an input device which accepts an input from a user, and a cover which is connected to the input device so as to be openable and closeable, and which covers at least part of the input device when it is closed. The information processor includes a hinge which connects the input device to the cover so that the input device and the cover are openable and closeable by rotation about a predetermined rotation axis, a frictional resistance maintaining section which maintains frictional resistance between the input device and the cover in the hinge to maintain the angle of the cover from the input device, an operating section which accepts from a user a reduction instruction to reduce the frictional resistance, and a frictional resistance reducing section which reduces the frictional resistance in the hinge when the reduction instruction is accepted.

### BACKGROUND OF THE INVENTION

The present invention relates to an information processor and a rotation control device. More particularly, the present invention relates to an information processorand a rotation control device which controls frictional resistance to rotation at an input device and a cover part mounted so as to be openable and closeable.

A device for enabling a display part for displaying information to a user to be set at an angle desired by the user (see patent document 1). This device is arranged to set the angle of rotation of a shaft in a hinge, and is light in weight and small in size.

(Patent document 1)

Published Unexamined Patent Application No. 2001-111253

The above-described device, however, does not enable a user to change the angle of rotation of the shaft by holding the display part when the angle of rotation of the shaft is set. That is, the device has been provided for the purpose of setting the angle of the display part and is incapable of adjusting the frictional resistance to the rotation of the hinge part when a user rotates the display by holding the display part. Further, if a malfunction occurs in the mechanism of the device for enabling the angle of rotation to be changed and the rotation angle is fixed, the angle of the display part cannot be changed by any amount.

### SUMMARY OF THE INVENTION

Therefore, a purpose of the present invention is to provide an information processor and a rotation control device provided as a solution to the above-described problem. This purpose can be attained by a combination of features described in the independent claims in the appended claims. In the dependent claims, further advantageous examples of the present invention are specified.

According to a first embodiment of the present invention, there is provided an information processor having an input device which accepts an input from a user, and a cover part which is connected to the input device so as to be openable and closeable, and which covers at least part of the input device when it is in a closed state, the information processor having a hinge part which connects the input device to the cover part so that the input device and the cover part are openable and closeable by rotation about a predetermined rotation axis, a frictional resistance maintaining section which maintains frictional resistance between the input device and the cover part in the hinge part to maintain the angle of the cover part from the input device, an operating section which accepts from a user a reduction instruction to reduce the frictional resistance, and a frictional resistance reducing section which reduces the frictional resistance in the hinge part when the reduction instruction is accepted.

In the summary of the present invention, not all the necessary features of the invention are listed. Subcombinations of the features can also constitute the present invention.

### BRIEF DESCRIPTION OF THE DRAWINGS

FIG. 1(a) is a top view, partly in section, of an information processor 10;

FIG. 1(b) is a side view of the information processor 10;

FIG. 2(a) is a front view of a frictional resistance maintaining section 400;

FIG. 2(b) is a side view of the frictional resistance maintaining section 400 shown in FIG. 2(a);

FIG. 2(c) is a side view in a case where the shape recovery temperature of the coiled spring 410 shown in FIG. 2(b) is set to a value different from ordinary temperature;

FIG. 3 is a diagram showing details of a frictional resistance maintaining section 400 in a first example of modification;

FIG. 4 is a diagram schematically showing an information processor 10 in a second example of modification;

FIG. 5(a) is a cross-sectional view of a torque release mechanism 430a and a shaft 420 parallel to the shaft 420;

FIG. 5(b) is a cross-sectional view of the shaft 420 and the torque release mechanism 430a at a position indicated by X;

FIG. 6(a) is a perspective view of a frictional resistance maintaining section 400, an internal portion being seen through part of a bearing part 425;

FIG. 6(b) is a front view of the frictional resistance maintaining section 400, the bearing part 425 being shown in a section taken along its diameter;

FIG. 6(c) is a side view of the frictional resistance maintaining section 400;

FIG. 6(d) is a side view of the frictional resistance maintaining section 400 when the operating section 220 receives a frictional resistance reduction instruction;

FIG. 7(a) is a perspective view of another frictional resistance maintaining section 400;

FIG. 7(b) is a diagram showing the frictional resistance maintaining section 400 when a shaft 480 maintains frictional resistance to a shaft 470; and

FIG. 7(c) shows the frictional resistance maintaining section 400 when the shaft 480 reduces the frictional resistance to the shaft 470.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

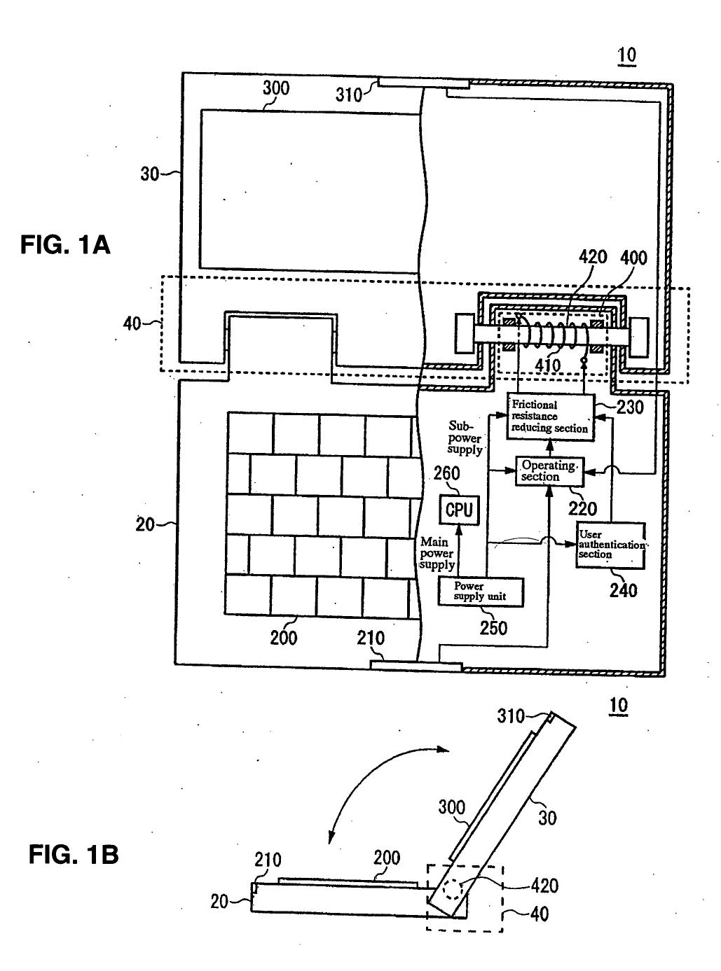

Referring now more particularly to the accompanying drawings, FIG. 1(a) is a top view, partly in section, of an information processor 10. FIG. 1(b) is a side view of the information processor 10. The information processor 10 is a personal computer, PDA, a portable communication terminal, orthe like. The information processor 10 has an input device 20 which accepts an input from a user, a cover part 30 which is connected to the input device 20 so as to be openable and closeable, and which covers at least part of the input device 20 when it is in a closed state, and a hinge part 40 which connects the input device 20 to the cover part 30 so that the input device 20 and the cover part 30 are openable and closeable by rotation about a predetermined rotation axis. The information processor 10 has been designed with the purpose of reducing frictional resistance caused in the hinge part 40 when a user opens or closes the cover part 30 in relation to the input device 20 to enable the cover part 30 to be smoothly opened or closed without applying an excessive force to the cover part 30.

The input device 20 is an example of the first part of the information processor 10. The input device 20 has a keyboard 200 which accepts an input from a user, a first switch 210, an operating section 220 (an operation detector, a switch detector, an instruction detector), a frictional resistance reducing section 230 (a friction controller, a friction-current controller, a friction-voltage controller, a friction processor), a user authentication section 240 (an authentication circuit, an authenticator), a power supply unit 250, and a CPU 260. The first switch 210 is provided on one of the input device 20 and the cover part 30, for example, on the input device 20. The operating section 220 accepts a frictional resistance reduction signal or instruction from a user by accepting an instruction or signal from each of the first switch 210 and a second switch 310. The frictional resistance reducing section 230 receives from the user authentication section 240 the result of authentication as to whether or not the user is authentic. When the instruction from both the first switch 210 and the second switch 310 is accepted and if the user is authentic, the frictional resistance reducing section 230 reduces frictional resistance in a frictional resistance maintaining section 400 (a restraint, a friction mechanism, a clutch mechanism) to a value smaller than a torque by which the user changes the angle. In a state where the input device 20 and the cover part 30 are opened, the frictional resistance reducing section 230 may reduce the frictional resistance regardless of the authentication result when a frictional resistance reduction instruction is accepted.

The user authentication section 240 authenticates a user by accepting insertion of a memory key indicating that the user is authentic, and notifies the frictional resistance reducing section 230 of the authentication result. The power supply unit 250 provides, as power supply from an AC adapter, a battery or the like, a plurality of power supplies, e.g., a main power supply and sub-power supply, each of which can be independently set on/off, to the sections of the information processor 10. For example, the power supply unit 250 provides a main power supply to the CPU 260, which is an example of the processing unit of the information processor 10, only when a power switch is on. The power supply unit 250 also provides a sub-power to the operating unit 220, the frictional resistance reducing section 230 and the user authentication section 240 even when the power switch is not on. That is, the operating unit 220, the frictional resistance reducing section 230 and the user authentication section 240 operate by a power supply different from the power supply for the operation of the processing unit of the information processor 10. In another example of the power supply system, it is not necessary for the power supply unit 250 to supply power to the operating unit 220. In this case, the operating unit 220 mechanically detects an operation for input from the first switch 210 and the second switch 310 by transmission through a shaft or the like, and transmits the detected input operation to the frictional resistance reducing section 230.

The cover part 30 is an example of the second part of the information processor 10. The cover part 30 has an output device 300 which outputs to a user the result of information processing in the CPU 260, and the second switch 310. The second switch 310 provided in the cover part 30 accepts an input from a user and notifies the operating section 220.

The hinge part 40 has the frictional resistance maintaining section 400, which is an example of the rotation control device. In a state where the information processor 10 is horizontally positioned and the input device 20 and the cover part 30 are opened, the frictional resistance maintaining section 400 maintains the frictional resistance in the hinge part 40 between the cover part 30 and the input device 20 to maintain the angle of the cover part 30 from the input device 20. More specifically, the frictional resistance maintaining section 400 has a shaft 420 fixed to one of the input device 20 and the cover part 30, and a coiled spring 410 having its opposite ends fixed to the other of the input device 20 and the cover part 30 and coiled around the shaft 420 to hold the shaft 420 by frictional resistance at ordinary temperature. In a state where the input device 20 and the cover part 30 are closed, the frictional resistance maintaining section 400 maintains the angle of the cover part 30 from the input device 20 by a frictional resistance larger than the torque by which a user changes the angle.

Thus, the frictional resistance maintaining section 400 maintains the angle of the cover part 30 from the input device 20 by frictional resistance such that the angle is not changed by the weight of the cover part 30 and the input device 20 in a state where the information processor 10 is horizontally positioned. The information processor 10 can reduce the frictional resistance in the frictional resistance maintaining section 400 when it receives a frictional resistance reduction instruction. Therefore, a user can set the cover part 30 at an angle according to user's need and can smoothly open or close the information processor 10 without applying an excessively large force to the cover part 30.

In this embodiment, the first switch 210 is a lever-type switch which accepts an input when touched or depressed by a user. Alternatively, the first switch 210 may be a knob-type switch which accepts when held by a user. The operating unit 220 may accept a frictional resistance reduction instruction by accepting an input from the first switch 210 regardless of an input from the second switch 310. That is, the operating unit 220 accepts the input of a frictional resistance reduction instruction by such a method that an erroneous input by a user is avoided. Thus, the operating section 220 can prevent the angle of the cover part 30 from the input device 20 from being inadvertently changed.

The information processor 10 may also have a latch mechanism which is provided to maintain the input device 20 and the cover part 30 in the closed state, and which uses a key-shaped member and a spring or the like to connect the input device 20 to the cover part 30. In such a case, the operating section 220 may accept as a frictional resistance reduction instruction an input from the switch for releasing the latch mechanism from the connecting state.

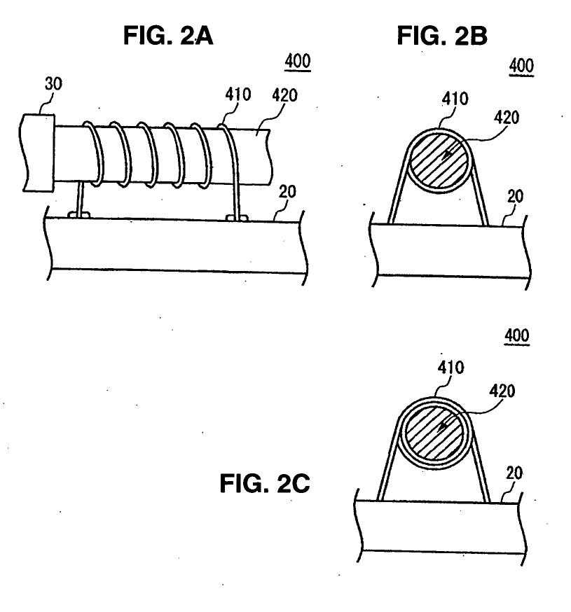

FIG. 2(a) is a front view of the frictional resistance maintaining section 400, and FIG. 2(b) is a side view of the frictional resistance maintaining section 400 shown in FIG. 2(a). The frictional resistance maintaining section 400 has the coiled spring 410 and the shaft 420. The shaft 420 is fixed to one of the input device 20 and the cover part 30, e.g., the cover part 30, as shown in this figure. The coiled spring 410 has its opposite ends fixed to the other of the input device 20 and the cover part 30, e.g., the input device 20, as shown in this figure. The coiled spring 410 is coiled around the shaft 420 to hold the shaft 420 by frictional resistance at ordinary temperature. A surface portion of the shaft 420 is formed of a material having frictional resistance higher than that of the material of the internal portion. For example, the surface portion of the shaft 420 is formed of a ceramic. Therefore, the frictional resistance maintaining section 400 is capable of maintaining the angle between the input device 20 and the cover part 30 by high frictional resistance even if the area of contact between the coiled spring 410 and the shaft 420, for example, in a case where the number of turns of the coiled spring 410 is small. Both the surface and internal portions of the shaft 420 may be formed of a ceramic. Alternatively, the internal portion may be formed of a metal having a strength higher than that of the ceramic.

FIG. 2(c) is a side view in a case where the shape recovery temperature of the coiled spring 410 shown in FIG. 2(b) is set to a value different from ordinary temperature. When the operating section 220 receives from a user a frictional resistance reduction instruction, the frictional resistance reducing section 230 causes an electric current to flow through the coiled spring 410 having a predetermined electrical resistance to set the coiled spring 410 at the shape recovery temperature. The frictional resistance reducing section 230 thereby increases the length of the coiled spring 410 from the length in the normal state to increase the inside diameter of the coiled spring 410. Thus, the frictional resistance reducing section 230 can reduce the frictional resistance on the surface of the shaft 420. For instance, in a case where the number of turns of the coiled spring 410 is ten and the memory length at the shape recovery temperature is longer than the normal length by three millimeters, the frictional resistance reducing section 230 can reduce the frictional resistance to substantially zero by making the coiled spring 410 float from the surface of the shaft 420 by about fifty microns. It is desirable that at least one of the coiled spring 410 and the shaft 420 be insulated in order to prevent electrical short-circuit.

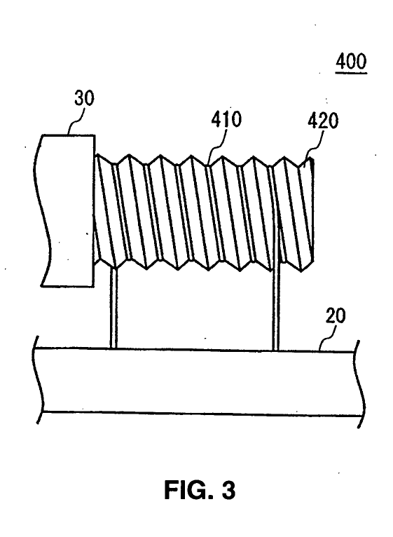

FIG. 3 shows details of a frictional resistance maintaining section 400 in a first example of modification. An information processor 10 in this example has the frictional resistance maintaining section 400 shown in FIG. 3 in place of the frictional resistance maintaining section 400 provided in the information processor 10 shown in FIG. 1. The other components of the information processor 10 in this example are substantially the same as those of the information processor shown in FIG. 1, and the description for the same components will not be repeated.

The frictional resistance maintaining section 400 has a shaft 420 having a helical groove formed in its surface, and a coiled spring 410 coiled around the shaft 420 in the groove to hold the shaft 420 by frictional resistance. In this example, the area of contact between the coiled spring 410 and the shaft 420 in this frictional resistance maintaining section 400 can be increased relative to that in the frictional resistance maintaining section 400 shown in FIG. 2. Therefore, the frictional resistance maintaining section 400 in this example can maintain the angle with higher frictional resistance.

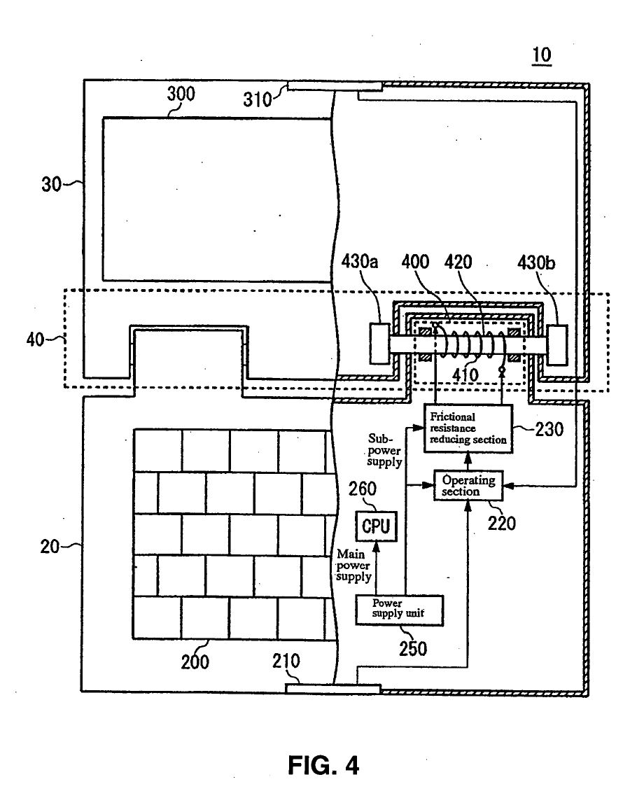

FIG. 4 is a diagram schematically showing an information processor 10 in a second example of modification. The information processor 10 is of such a construction that a torque release mechanisms 430a and 430b are further provided in the information processor 10 shown in FIG. 1. It is not necessary for the information processor 10 in this example to have the user authentication section 240. In other respects, the construction of the information processor 10 is substantially the same as that of the information processor 10 shown in FIG. 1. Only the points of difference from the information processor 10 shown in FIG. 1 will be described. The frictional resistance maintaining section 400 has a shaft 420 provided between the input device 20 and the cover part 30, and a coiled spring 410 provided on one of the input device 20 and the cover part 30, e.g., the input device 20, as shown in this figure.

The coiled spring 410 is a coil of a shape-memory alloy coiled around the shaft 420 to hold the shaft 420 by frictional resistance at ordinary temperature. The torque release mechanism 430a rotates the cover part 30 relative to the input device 20 to release a torque externally applied between the cover part 30 and the input device 20 if the externally applied torque is larger than a magnitude set in advance. The torque release mechanism 430b is substantially the same as the torque release mechanism 430a. Therefore, Further description will not be made of the torque release mechanism 430b.

Any shape-memory alloy (SMA) such as nickel-titanium can be used for the shape-memory alloy. SMA's have useful shape-recovery and superelastic properties of which stem from a transition between two crystal forms: a malleable martensitic phase at an ordinary temperature usually below the material's transformation temperature band (Ttr) and a stiff austenitic phase above Ttr. The transition is rapid and readily reversible. SMA's require relatively little energy and—unlike most alloys—do not require atomic diffusion to make the transition between the phases. Most commercial SMA's are nickel-titanium, also referred to as Nitinol; copper-zinc-aluminum; or copper-aluminum-nickel alloys. The materials are available in many forms including bars, strips, wires, tubing, foils, and thin films. Shape recovery occurs when an SMA piece undergoes deformation while in the malleable low temperature phase and then encounters heat greater than Ttr. One can use any heat source; magnetic induction and direct resistance heating (passing current through the SMA) offer electronic control of the heating as described above. Depending on the alloy used, the shape-memory alloy can be made to either shrink or enlarge when using direct resistance heating.

In this example of modification, the frictional resistance maintaining section 400 maintains the angle of the cover part 30 from the input device 20 by frictional resistance such that the angle is not changed by the weight of the cover part 30 and the input device 20 in a state where the information processor 10 is horizontally positioned. On the other hand, the torque release mechanism 430a can rotate the cover part 30 relative to the input device 20 when a torque is applied by a user to change the angle.

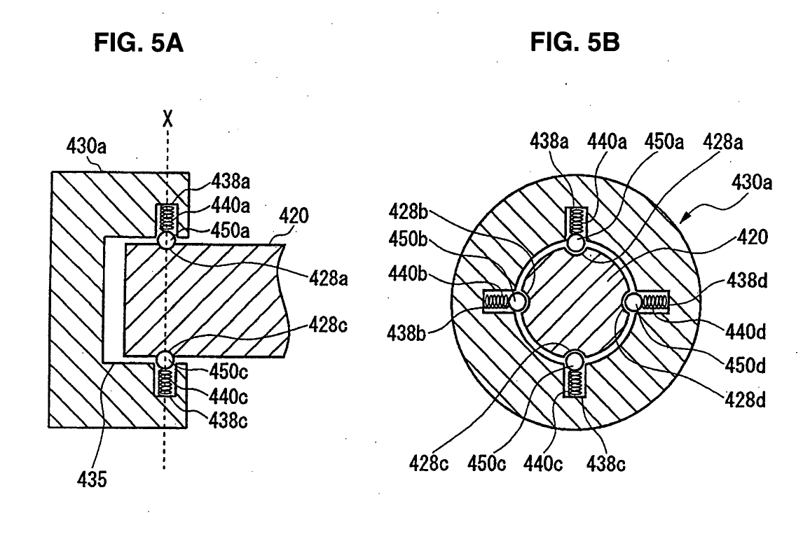

FIG. 5(a) is a cross-sectional view of the torque release mechanism 430a and the shaft 420 parallel to the shaft 420. FIG. 5(b) is a cross-sectional view of the shaft 420 and the torque release mechanism 430a at a position indicated by X. The shaft 420 has recessed portions 428a to 428d formed in its surface at intervals of predetermined rotation angles, e.g., 90°. The torque release mechanism 430a has a shaft supporting portion 435 for rotatably supporting an end of the shaft 420, spring accommodation portions 438a to 438d provided in an inner wall portion of the shaft supporting portion 435 in correspondence with the recessed portions 428a to 428d, springs 440a to 440d accommodated in the spring accommodation portion 438a to 438d, and spherical members 450a to 450d respectively provided in spaces between the springs 440a to 440d and the recessed portions 428a to 428d. The spherical members 450a to 450d are respectively pressed against the recessed portions 428a to 428d of the shaft 420 by the forces of expansion of the springs 440a to 440d to maintain the frictional resistance of the shaft 420.

When the shaft 420 is rotated through a predetermined angle of rotation, the torque release mechanism 430a maintains the angle of rotation of the shaft 420 by a frictional resistance of a magnitude set in advance according to the expansion force of the springs and the sizes of the spherical members 450 and the recessed portions 428. When a torque largerthan the value set in advance is externally applied between the cover part 30 and the input device 20, the spherical members 450 in the torque release mechanism 430a are pressed in the direction of the spring accommodation portions by the torque to be released from the recessed portions 428. As a result, the shaft 420 is made rotatable relative to the torque release mechanism 430a to rotate the cover part 30 relative to the input device 20.

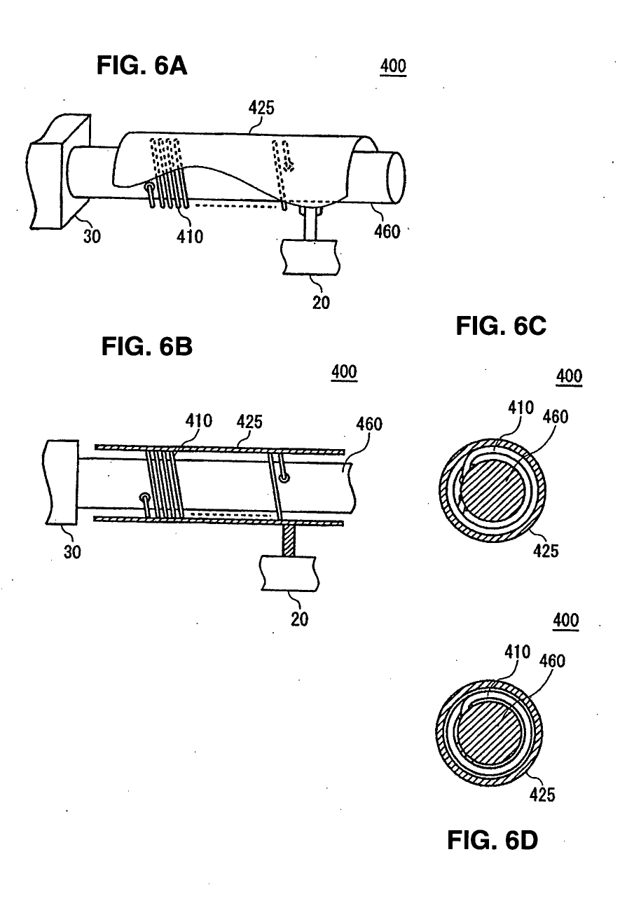

FIG. 6(a) is a perspective view of another frictional resistance maintaining section 400, an internal portion being seen through part of a bearing part 425. An information processor 10 in this example has the frictional resistance maintaining section 400 shown in this figure in place of the frictional resistance maintaining section 400 provided in the information processor 10 shown in FIG. 1. The other components of the information processor 10 in this example are substantially the same as those of the information processor shown in FIG. 1, and the description for the same components will not be repeated. The frictional resistance maintaining section 400 has a shaft 460, which is an example of the predetermined rotating shaft, a coiled spring 410 made of a shape-memory alloy and fixed on the cover part 30 with its opposite ends fixed to the shaft 460, and the bearing part 425, which is tubular, which is fixed to the input device 20, and which holds the outer periphery of the coiled spring 410 by predetermined frictional resistance at ordinary temperature.

FIG. 6(b) is a front view of the frictional resistance maintaining section 400, the bearing part 425 being shown in a section taken along its diameter. FIG. 6(c) is a side view of the frictional resistance maintaining section 400. The coiled spring 410 is in contact with the inner wall surface of the bearing part 425. The bearing part 425 supports the outer periphery of the coiled spring 410 by predetermined frictional resistance. That is, at ordinary temperature, the frictional resistance maintaining section 400 maintains frictional resistance between the input device 20 and the cover part 30 by friction between the coiled spring 410 and the bearing part 425 caused by the force by which the coiled spring 410 presses the inner wall surface of the bearing part 425.

FIG. 6(d) is a side view of the frictional resistance maintaining section 400 when the operating section 220 receives a frictional resistance reduction instruction. The frictional resistance reducing section 230 causes an electric current to flow through the coiled spring 410 by supplying the current through the cover part 30 and the shaft 460. The coiled spring 410 is thereby set at a shape recovery temperature different from ordinary temperature to be reduced in length from its length at ordinary temperature, thereby reducing the diameter of the coiled spring 410. As a result, the force of the coiled spring 410 causing a tension in the bearing part 425 is reduced to reduce the frictional resistance between the input device 20 and the cover part 30.

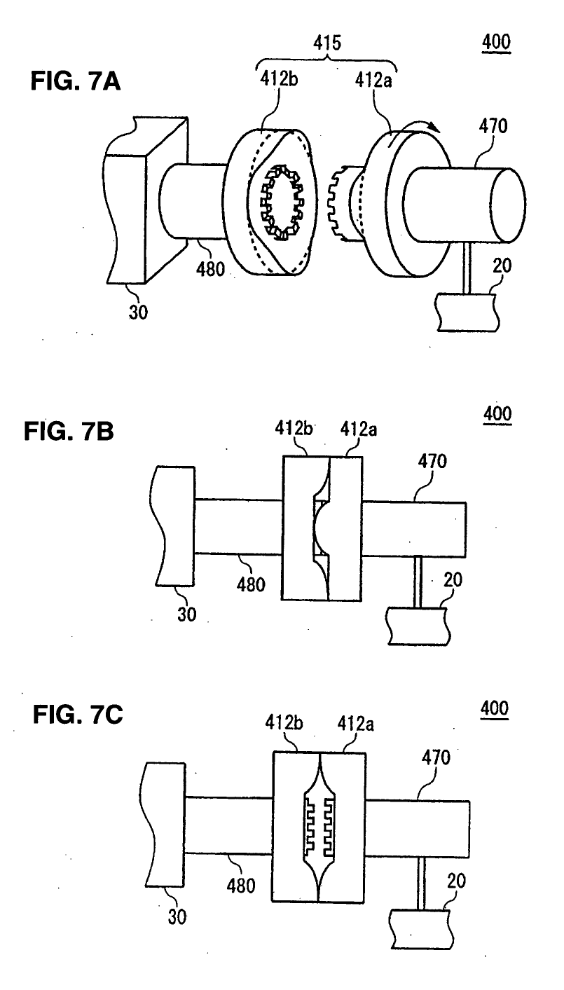

FIG. 7(a) is a perspective view of another frictional resistance maintaining section 400. An information processor 10 in this example has the frictional resistance maintaining section 400 shown in this figure in place of the frictional resistance maintaining section 400 provided in the information processor 10 shown in FIG. 1. The other components of the information processor 10 in this example are substantially the same as those of the information processor 10 shown in FIG. 1, and the description for the same components will not be repeated.

The frictional resistance maintaining section 400 has a shaft 470 fixed to the input device 20, a shaft 480 fixed to the cover part 30, and a clutch 415 which maintains frictional resistance between the shaft 480 and the shaft 470 to maintain the angle of rotation of the shaft 480 relative to the shaft 470. The shaft 470 has a toothed wheel formed its one end surface. The shaft 480 has a toothed wheel formed at its one end surface for engagement with the toothed wheel of the shaft 470.

The clutch 415 has a ring-like element 412a rotatable relative to the shaft 470 and provided on the outer surface of the shaft 470 in the vicinity of the end surface of the shaft 470, and a ring-like element 412b rotatable relative to the shaft 480 and provided on the outer surface of the shaft 480 in the vicinity of the end surface of the shaft 480.

In this figure, the shaft 470 and the shaft 480 are shown in a state of being separated from each other for explanation of details of the shapes of the components. In actual construction, the shaft 470 is provided close to the shaft 480 to engage with the shaft 480 at the toothed wheel of the end surface.

FIG. 7(b) shows the frictional resistance maintaining section 400 when the shaft 480 maintains frictional resistance to the shaft 470. The ring-like element 412a and the ring-like element 412b have projections on their surfaces facing each other. As shown in this figure, the end surface of the shaft 470 and the end surface of the shaft 480 engage with each other by the toothed wheels when the projections of the ring-like element 412a do not contact the projections on the ring-like element 412b, that is, the projections of the ring-like element 412a contact recessed portions of the ring-like element 412b different from the projections. That is, the clutch 415 maintains the frictional resistance between the shaft 480 and the shaft 470 by setting the projections of the ring-like element 412a in a state of not contacting the projections of the ring-like element 412b.

FIG. 7(c) shows the frictional resistance maintaining section 400 when the shaft 480 reduces the frictional resistance to the shaft 470. As shown in this figure, the end surface of the shaft 470 and the end surface of the shaft 480 do not engage with each other when the projections of the ring-like element 412a contact the projections of the ring-like element 412b. That is, the frictional resistance reducing section 230 rotates the ring-like element 412a relative to the ring-like element 412b to set the projections of the ring-like element 412a in a state of contacting the projections of the ring-like element 412b, thereby separating the toothed wheels of the shafts 480 and 470 from each other. The frictional resistance is thereby reduced. For example, as a method of rotating the ring-like element 412a relative to the ring-like element 412b, a method may be used in which the frictional resistance reducing section 230 mechanically transmits an input operation accepted by the first and second switches 210 and 310, or a method may be used in which at least one of the ring-like element 412a and the ring-like element 412b is rotated by being pulled by a wire made of a shape-memory alloy or a solenoid.

As described above, the information processor 10 is capable of reducing frictional resistance caused in the hinge part 40 when a user opens or closes the cover part 30 and is, therefore, capable of preventing the cover part 30 from being warped or broken. A user can open or close the cover part 30 without feeling any substantial load. Moreover, the user can open or close the cover part 30 without feeling a “creak” in the right and left hinges and, by his or her hand, “unsteadiness” of the cover part 30 manufactured as a thin type. Further, the cover part 30 of the information processor 10 can be suitably opened and closed even in a case where the thickness of the LCD panel is reduced by technological innovation in future to enable the cover part 30 to be reduced in thickness, or in a case where the cover part 30 has a flexible liquid crystal panel.

In the state where the input device 20 and the cover part 30 are closed, the information processor 10 reduces the frictional resistance when the authenticity of a user is confirmed. Thus, the information processor 10 does not allow an unauthorized user to use the input device, i.e., the keyboard or the like, and the output device, i.e., the LCD panel or the like, and unauthorized use of the information processor 10 can be effectively prevented.

In the drawings and specifications there has been set forth a preferred embodiment of the invention and, although specific terms are used, the description thus given uses terminology in a generic and descriptive sense only and not for purposes of limitation.

1. Apparatus comprising:
an input device which accepts user input;
a cover;
a hinge which connects the input device to the cover so that the input device and the cover are openable and closeable by rotation about a predetermined rotation axis, wherein the cover covers at least part of the input device while in a closed position;
a restraint which maintains frictional resistance between the input device and the cover to maintain an angle between the cover and the input device;
an operation detector which is coupled to said restraint and which accepts a reduction instruction provided by a user to reduce the frictional resistance; and
a friction controller which is coupled to said restraint and which reduces the frictional resistance in said hinge when the reduction instruction is accepted.

2. Apparatus of claim 1 wherein said cover has an output device which outputs user information, and said restraint maintains the frictional resistance to maintain the angle.

3. Apparatus of claim 1 wherein said operation detector draws power from a first power supply which is other than a power supply used for the operation of a processing unit.

4. Apparatus of claim 1, further comprising:
a first switch provided on one of said input device and said cover; and
a second switch provided on the other of said input device and said cover;
wherein said operation detector accepts the reduction instruction by accepting an instruction from each of said first switch and said second switch, and
wherein said friction controller reduces the frictional resistance in the restraint in response to the instruction from each of said first switch and said second switch is accepted.

5. Apparatus of claim 1 wherein said restraint further includes:
a shaft fixed to one of said input device and said cover; and
a coiled spring made of a shape-memory alloy and having its opposite ends fixed to the other of said input device and said cover and coiled around said shaft to hold said shaft by the frictional resistance at ordinary temperature;
wherein said friction controller increases the length of said coiled spring relative to the length at the ordinary temperature by setting said coiled spring at a shape recovery temperature to reduce the frictional resistance when said operation detector accepts the reduction instruction.

6. Apparatus of claim 5 wherein a helical groove is formed in a surface of said shaft, and said coiled spring is coiled around said shaft along said groove to maintain said shaft by the frictional resistance.

7. Apparatus of claim 5 wherein a material forming a surface portion of said shaft has a friction coefficient larger than that of a material forming an inner portion of said shaft.

8. Apparatus of claim 1 wherein said restraint maintains the angle by the frictional resistance which prevents the angle from being changed by the weight of said input device and said the cover in a state where said input device is horizontally positioned.

9. Apparatus of claim 8 wherein said restraint maintains the angle by applying a frictional resistance which is smaller than a user supplied torque for changing the angle.

10. Apparatus of claim 1, further comprising:
a torque release which allows for the rotation release of said cover relative to said input device in response to a torque externally applied between said cover and said input device if the externally applied torque is larger than a predetermined magnitude.

11. Apparatus of claim 10 wherein said restraint further comprises:
a shaft provided between said input device and said cover; and
a coiled spring made of a shape-memory alloy, provided on one of said cover and said input device, and coiled around said shaft to hold said shaft by the frictional resistance at ordinary temperature;
wherein said torque release mechanism is provided on the other of said cover and said input device to hold said shaft by a predetermined torque.

12. Apparatus of claim 1, further comprising:
a user authentication circuit coupled to said restraint which authenticates a user;
wherein said restraint maintains the angle by applying a frictional resistance which is larger than a user supplied torque which changes the angle in a state where said input device and said cover are closed; and
wherein said restraint reduces the frictional resistance to a value smaller than a user supplied torque which changes the angle in a state where said input device and said cover are closed if the authenticity of the user is confirmed.

13. A rotation control device which connects a first part and a second part so that the first part and the second part are openable and closeable, and which controls the rotation of the second part on a shaft connected to the first part, said rotation control device comprising a coiled spring which has its opposite ends connected to the second part, which is wrapped around the shaft at an ordinary temperature to hold the shaft by a predetermined frictional resistance, which increases in length from its length at the ordinary temperature to reduce the frictional resistance when set at a shape recovery temperature different from the ordinary temperature, and which is made of a shape-memory alloy.

14. Apparatus comprising:
a hinge which connects a first part to a second part so that the first part and the second part are openable and closeable by rotation about a predetermined rotation axis;
a coiled spring which has its opposite ends connected to the second part, and which is made of a shape-memory alloy; and
a bearing part which is connected to the first part, and which holds the periphery of said coiled spring at an ordinary temperature by a predetermined frictional resistance;
wherein said coiled spring is reduced in length from its length at the ordinary temperature by being set at a shape recovery temperature different from the ordinary temperature to reduce the frictional resistance.

15. A method comprising:
generating a first electrical signal which affects the flow of current through a shape-memory-alloy wire which surrounds a shaft which couples a first and second portion of a device, wherein the first electrical signal causes the shape-memory-alloy wire to have a first length which tends to grasp the shaft and produce a predetermined rotational friction between the first and second portions;
accepting a second signal;
generating a third electrical signal which affects the flow of current through the shape-memory-alloy wire, wherein the third electrical signal causes the shape-memory-alloy wire to have a second length which tends to release the shaft and produce a second predetermined rotational friction which is lower than the first predetermined rotational friction, wherein the third electrical signal is generated in response to accepting the second signal.
